(19) United States
(12) Patent Application Publication
(10) Pub. No.: US 2010/0044536 A1
(43) Pub. Date: Feb. 25, 2010

(54) HANGING FRAME FOR DISPLAY

(76) Inventor: Ming-Hua Huang, Kau-Hsiung (TW)

Correspondence Address: Ming-Hua Huang, 235 Chung-Ho, Box 8-24, Taipei, TW

(21) Appl. No.: 12/607,072

(22) Filed: Oct. 28, 2009

Related U.S. Application Data
(63) Continuation-in-part of application No. 11/219,952, filed on Sep. 7, 2005, now abandoned.

(51) Int. Cl. F16M 13/00

(52) U.S. Cl. 248/201

(57) ABSTRACT

A hanging frame for a display comprises: a first frame capable of being fixed to a wall and a second frame capable being fixed to a backside of a display; wherein the first frame has a left frame and a right frame which are screwed to a wall; an upper side of each left frame and right frame has a respective hanging groove; a transversal rod is located at a lower side of the left frame and the right frame; a left retaining sheet and a right retaining sheet are engaged to the transversal rod; each of a left end and a right end is formed with a screw hole; the second frame has a similar structure like that of the first frame, while the left frame and right frame of the second frame serves to be screwed to the a backside of a display.

The present invention is a continuation in part (CIP) of U.S. patent application Ser. No. 11/219,952 which is assigned to the inventor of the present invention. Thus the contents of the application U.S. Ser. No. 11/219,952 is incorporated into the present invention as a part of the invention.

FIELD OF THE INVENTION

The present invention relates to displays, and particularly to a hanging frame for a display which can hang a LCD display or a plasma display to a wall steadily. The hanging frame for a display is adjustable with the size of the display.

### BACKGROUND OF THE INVENTION

Since the liquid crystal displays and plasma display are made thinner and thinner for occupying less space, they are often suspended to walls. One prior art display suspending frame (referring to FIG. 1) is formed by a retaining seat capable of being retained to a wall 30 and a suspending seat 20 capable of being fixed to a display 40.

The retaining seat 10 (referring to FIGS. 2 and 3) is a rectangular seat by punching a metal. A periphery thereof is formed with a frame 11 which can be flatly adhered to a wall 30. an edge of the frame 11 is formed with a plurality of holes 12 for passing studs to lock to the wall 30 so as to fix the retaining seat 10 to the wall 30. a center of the retaining seat 10 is pushed forwards as a plane. Two sides of the plane are formed with respective suspending holes 13. the holes at upper sides are larger than those at lower sides.

The suspending seat 20 (referring to FIGS. 2 and 3) is a rectangular seat by punching a metal. A periphery thereof has a frame 21 which can be flatly adhered upon the backside of a display 40. the frame 21 has a plurality of holes 22. studs pass through the holes so as to be locked to the display 40. thereby the suspending seat 20 can be retained to the display 40. a center of the suspending seat 20 is punched with a rear convex plane. Two sides of the plane are installed with rear convex suspending posts 23. a rear end of each suspending post 23 is formed with a larger head 24. the suspending post 23 is corresponding to the suspending hole 13 of the retaining seat 10.

By above mentioned structure, in use of the prior art display, the studs serve to fix the retaining seat 10 upon the wall 30. studs serves to fix the suspending seat 20 to the display 40. then the suspending posts 23 on the suspending seat 20 pass through the suspending holes 13 having larger sizes. Then the suspending posts 23 move downwards to the holes 13 having smaller sizes so that the suspending posts 23 are engaged to the holes 13 by the larger heads 24 at the rear end thereof. Thereby the display 40 can be suspended to the wall 30.

However due to the improvement of technology, displays of different sizes are developed and are widely used in daily life (such as plasma tvs or liquid crystal tvs). In the prior art, only the heads 24 of the suspending posts 23 of the suspending seat 20 and the holes 13 of the retaining seat 10 are used in fixing. The suspending posts 23 are formed on the retaining seat 10 directly, which have low tolerance in bearing an object. If the size of the display is great, it is easily destroyed or the display falls down. Furthermore, the size of the prior art display suspending frame has a fix type. It is unchangeable with the sizes of the displays. Thus, it is not suitable for displays of various sizes.

### SUMMARY OF THE INVENTION

Accordingly, the object of the present invention is to provides a hanging frame for a display which can hang a LCD display or a plasma display to a wall steadily.

Another object of the present invention is to provides a hanging frame for a display which is adjustable with the size of the display.

To achieve above object, the present invention provides a hanging frame for a display comprising: a first frame capable of being fixed to a wall and a second frame capable being fixed to a backside of a display; wherein the first frame has a left frame and a right frame which are screwed to a wall; an upper side of each left frame and right frame has a respective hanging groove; a transversal rod is located at a lower side of the left frame and the right frame of the first frame; a left retaining sheet and a right retaining sheet are engaged to the transversal rod of the first frame; each of a left end and a right end is formed with a screw hole; the second frame has a left frame and a right frame which are screwed to the a backside of a display; an upper side of each left frame and right frame has a respective hanging groove; another transversal rod is located at a lower side of the left frame and the right frame of the second frame; another left retaining sheet and another right retaining sheet are engaged to the transversal rod of the second frame; each of a left end and a right end is formed with a screw hole; wherein by above said structure, the first frame can be locked to the wall by the left frame and the right frame of the first frame; the second frame can be locked to a backside of the display by the left frame and the right frame of second frame; then the transversal rod of the second frame is located in the hanging grooves of the left frame and the right frame of the first frame; the transversal rod of the first frame is located in the hanging grooves of the left frame and the right frame of the second frame; studs are used to lock the left retaining sheet and the right retaining sheet of the first frame to the left frame and the right frame of the second frame, and studs serve to lock the left retaining sheet and right retaining sheet of the transversal rod of the second frame to the left frame and the right frame of the first frame so that the display is steadily locked to the wall.

The various objects and advantages of the present invention will be more readily understood from the following detailed description when read in conjunction with the appended drawing.

### BRIEF DESCRIPTION OF THE DRAWINGS

FIG. 1 is a exploded perspective view of the prior art hanging frame for a display.

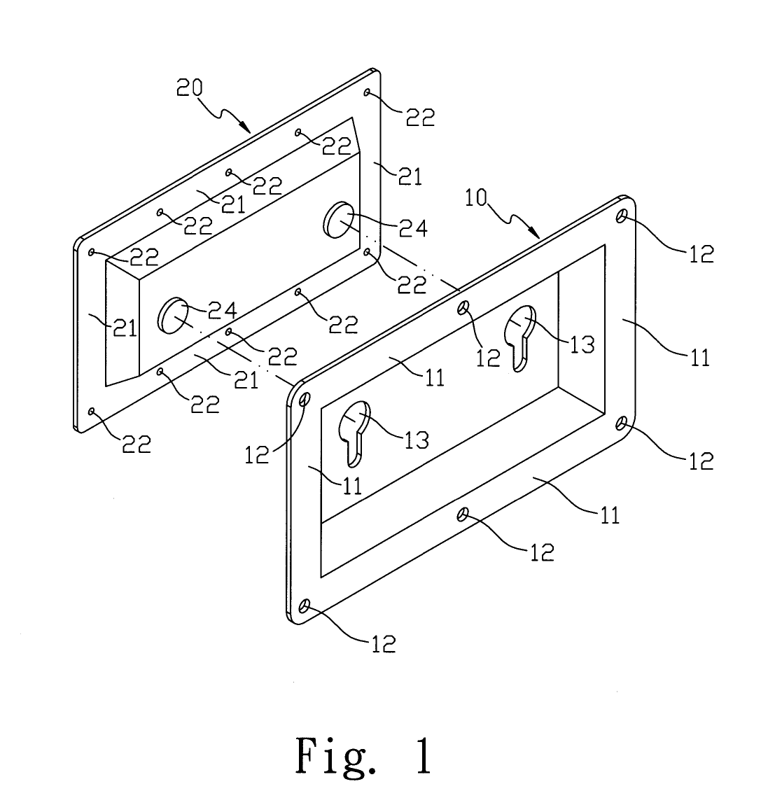

FIG. 2 is an assembly view of a prior art hanging frame for a display.

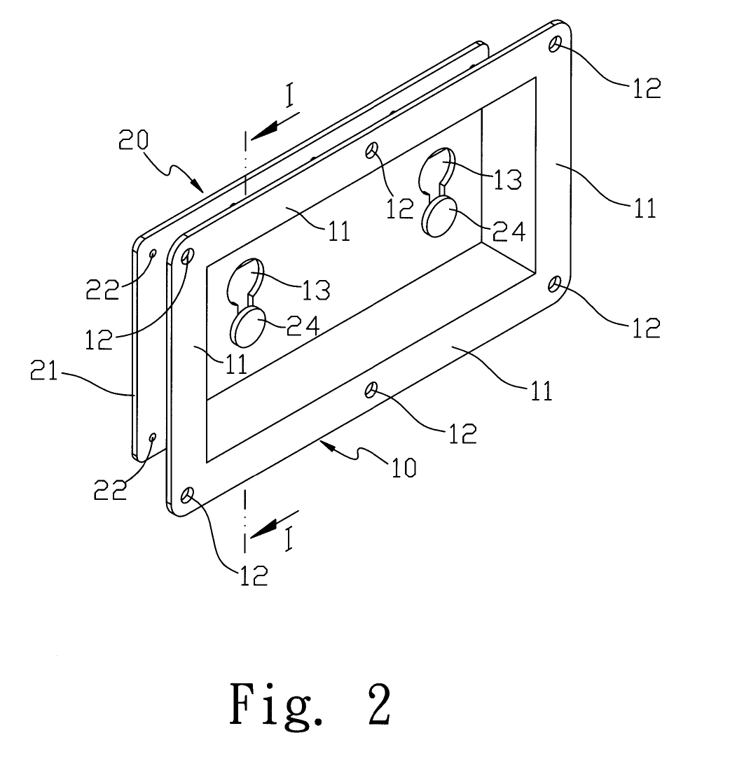

FIG. 3 is a cross sectional view along line I-I of FIG. 2.

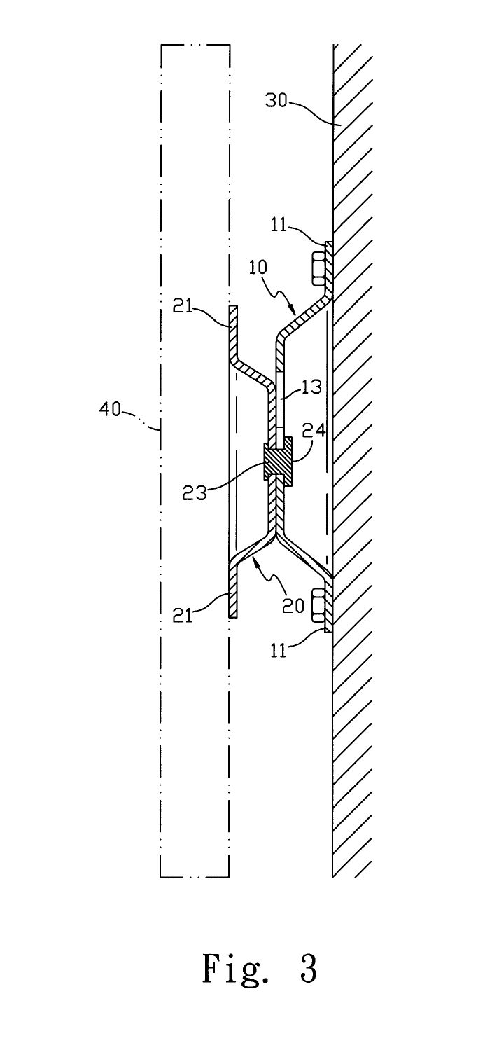

FIG. 4 is an exploded perspective view of the present invention.

FIG. 5 is an assembled perspective view of the present invention.

FIG. 6 is a front schematic view showing the assembly of the present invention.

FIG. 7 is a cross sectional view along line II-II of FIG. 6.

FIG. 8 is a cross sectional view along line III-III of FIG. 6.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

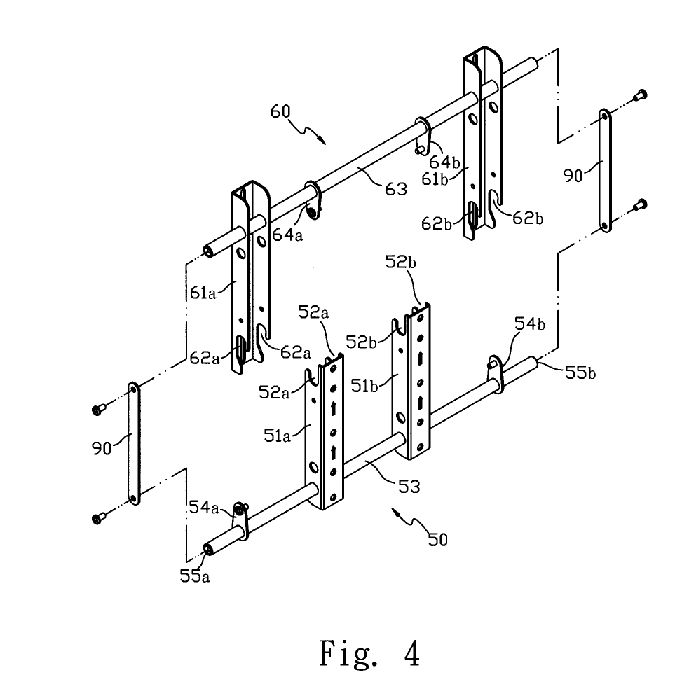

Referring to FIG. 4, the present invention includes a first frame 50 fixed to a wall and a second frame 60 fixed to a backside of a display 80.

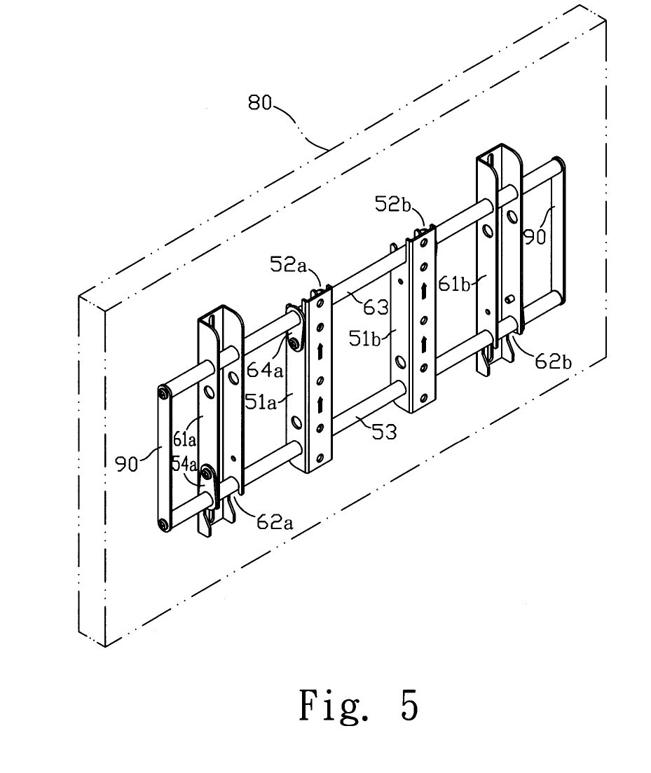

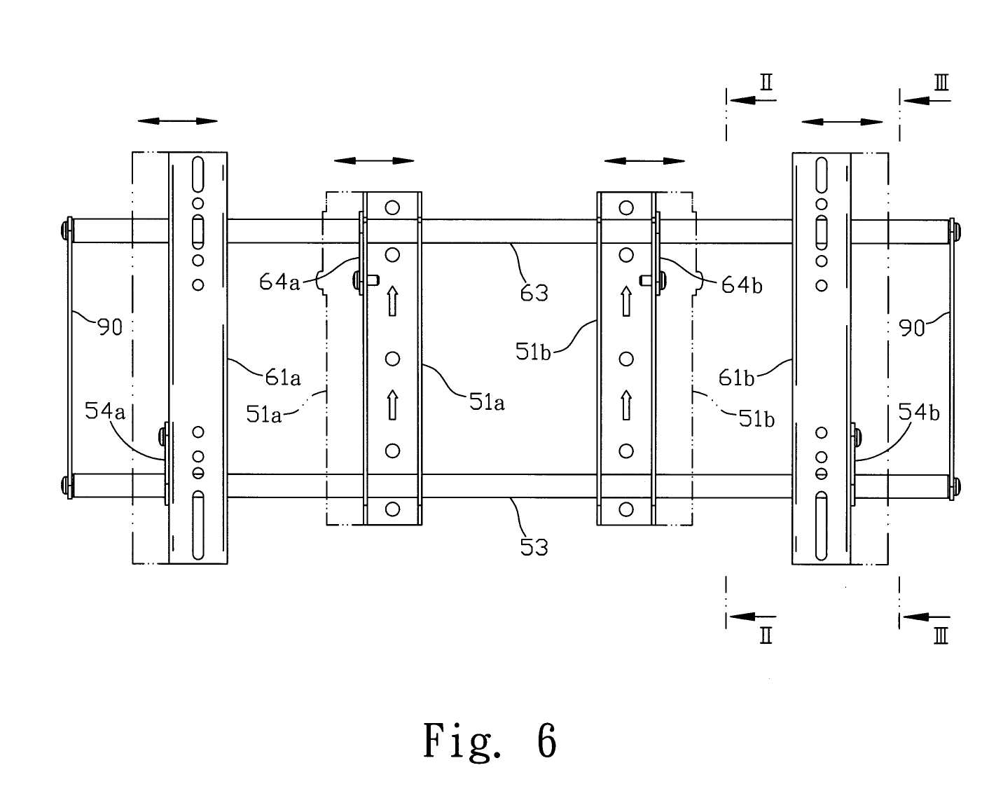

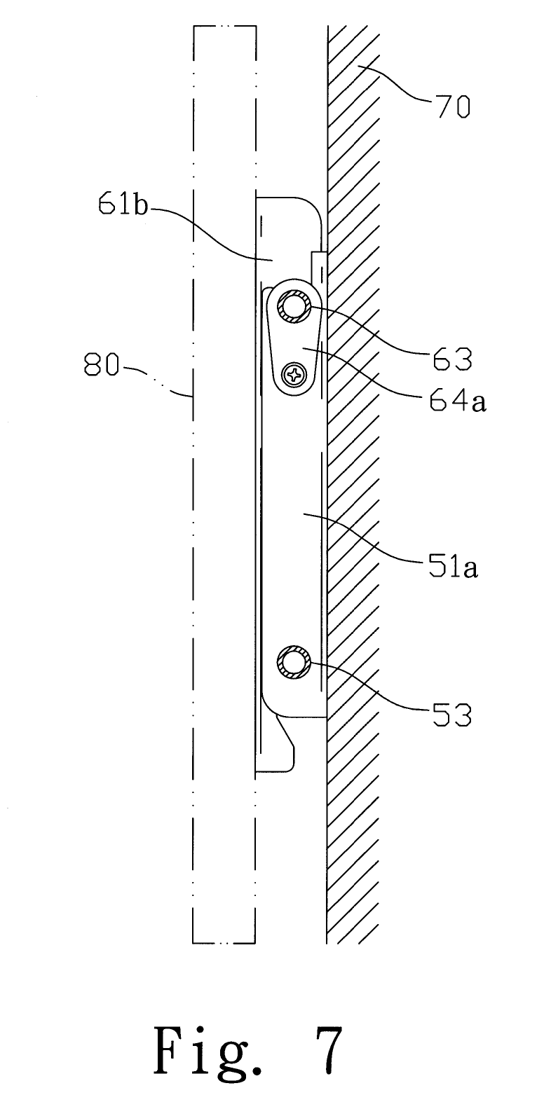

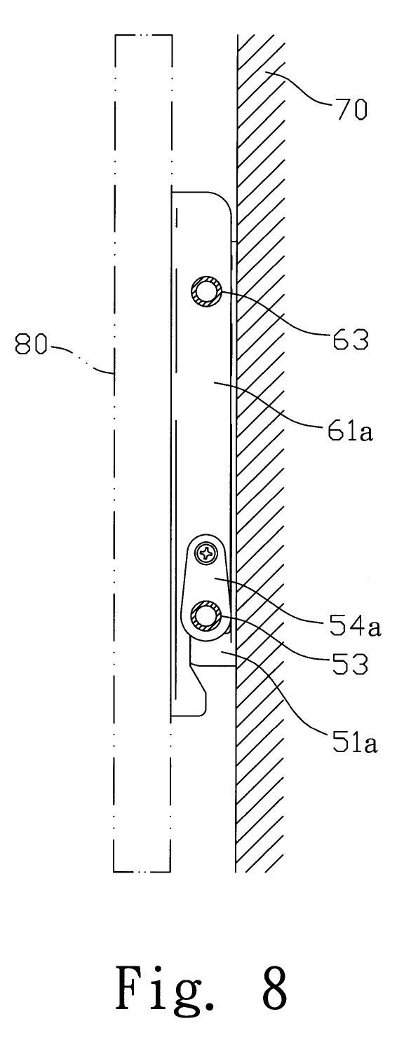

The first frame 50 (referring to FIGS. 4 and 5) has a left frame 51a and a right frame 51b which are screwed to the wall 70 (referring to FIGS. 7 and 8). An upper side of each left frame 51a and right frame 51b has a respective hanging groove 52a, 52b. A transversal rod 53 is located at a lower side of the left frame 51a and the right frame 51b. The distance between the left frame 51a and the right frame 51b is adjustable along the transversal rod 53 (referring to FIG. 6). A left retaining sheet 54a and a right retaining sheet 54b are engaged to the transversal rod 53. Each of a left end and a right end is formed with a screw hole 55a, 55b.

The second frame 60 (referring to FIGS. 4 and 5) has a left frame 61a and a right frame 61b which are screwed to the a backside of a display 80 (referring to FIGS. 7 and 8). An upper side of each left frame 61a and right frame 61b has a respective hanging groove 62a, 62b. A transversal rod 63 is located at a lower side of the left frame 61a and the right frame 61b. The distance between the left frame 61a and the right frame 61b is adjustable along the transversal rod 63 (referring to FIG. 6). A left retaining sheet 64a and a right retaining sheet 64b are engaged to the transversal rod 63. Each of a left end and a right end is formed with a screw hole 65a, 65b.

By above said structure, the first frame 50 can be locked to the wall by the left frame 51a and the right frame 51b. The second frame 60 can be locked to a backside of the display 80 by the left frame 61a and the right frame 61b. Then the transversal rod 63 of the second frame 60 is located in the hanging grooves 52a, 52b of the left frame 51a and the right frame 51b of the first frame 50. The transversal rod 53 of the first frame 50 is located in the hanging grooves 62a, 62b of the left frame 61a and the right frame 61b of the second frame 60. Then studs are used to lock the left retaining sheet 54a and the right retaining sheet 54b of the first frame 50 to the left frame 61a and the right frame 61b of the second frame 60, and studs serve to lock the left retaining sheet 64a and right retaining sheet 64b of the transversal rod 63 of the second frame 60 to the left frame 51a and the right frame 51b of the first frame 50 so that the display 80 is steadily locked to the wall 70. Furthermore, in the present invention, each of two ends of each transversal rod of the first frame 50 and second frame 60 can be installed with a stopper 90 which is locked to the transversal rod by stud.

From above description and the drawing, it is known that the structure of the present invention can achieve the above mentioned object of the present invention. The hanging frame for a display of the present invention can suspend a display on a wall steadily. In the present invention, a distance between the left frame 51a and the right frame 51b of the first frame 50 is adjustable along the transversal rod 53. And a distance between the left frame 61a and the right frame 61b of the second frame 60 is adjustable along the transversal rod 63. Thus the size of the present invention is adjustable for suiting the display of different size. Therefore, as comparing with the prior art, the present invention is inventive and novel.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A hanging frame for a display comprising: a first frame capable of being fixed to a wall and a second frame capable being fixed to a backside of a display; wherein
the first frame has a left frame and a right frame which are screwed to a wall; an upper side of each left frame and right frame has a respective hanging groove; a transversal rod is located at a lower side of the left frame and the right frame of the first frame; a left retaining sheet and a right retaining sheet are engaged to the transversal rod of the first frame; each of a left end and a right end is formed with a screw hole;
the second frame has a left frame and a right frame which are screwed to the a backside of a display; an upper side of each left frame and right frame has a respective hanging groove; another transversal rod is located at a lower side of the left frame and the right frame of the second frame; another left retaining sheet and another right retaining sheet are engaged to the transversal rod of the second frame; each of a left end and a right end is formed with a screw hole;
wherein by above said structure, the first frame can be locked to the wall by the left frame and the right frame of the first frame; the second frame can be locked to a backside of the display by the left frame and the right frame of second frame; then the transversal rod of the second frame is located in the hanging grooves of the left frame and the right frame of the first frame; the transversal rod of the first frame is located in the hanging grooves of the left frame and the right frame of the second frame; studs are used to lock the left retaining sheet and the right retaining sheet of the first frame to the left frame and the right frame of the second frame, and studs serve to lock the left retaining sheet and right retaining sheet of the transversal rod of the second frame to the left frame and the right frame of the first frame so that the display is steadily locked to the wall.

2. The hanging frame for a display as claimed in claim 1, wherein a distance between the left frame and the right frame of the first frame is adjustable along the transversal rod of the first frame.

3. The hanging frame for a display as claimed in claim 1, wherein a distance between the left frame and the right frame of the second frame is adjustable along the transversal rod of the second frame.

4. The hanging frame for a display as claimed in claim 1, wherein each of two ends of each transversal rod of the first frame and second frame is installed with a stopper which is locked to the transversal rod by stud.
